(19) United States
(12) Patent Application Publication
(10) Pub. No.: US 2017/0236444 A1
(43) Pub. Date: Aug. 17, 2017

(54) TRAINING SYSTEM FOR A USER TO TROUBLESHOOT PROBLEMS IN AN HVAC PROCESS

(71) Applicant: John Feris, Niceville, FL (US)

(72) Inventor: John Feris, Niceville, FL (US)

(21) Appl. No.: 15/041,941

(22) Filed: Feb. 11, 2016

(51) Int. Cl. G09B 19/00

(52) U.S. Cl. CPC G09B 19/00

(57) ABSTRACT

A training system is disclosed here for a user to troubleshoot problems in an HVAC process by comparing HVAC components with human body parts. The training system comprises a self-diagnostic thermostat configured to facilitate a user to compare components in the HVAC process to human body parts. Here, the self-diagnostic thermostat is compared to a brain of the human body, a compressor of the HVAC components is compared to a heart of the human body, an evaporator of the HVAC components is compared to a pair of lungs of the human body, and suction and liquid dryers of the HVAC components are compared to kidneys of the human body.

### BACKGROUND

HVAC systems comprising, namely, refrigeration and air conditioning, around the world are controlled and operated according to operating standards that are set by the manufacturing company. Written manuals are provided along with most HVAC systems which clearly illustrate the operating conditions of each of such systems. However, some of the skilled and semi-skilled operators find it difficult to understand the manuals, and so their ways of operation of the HVAC systems tends to be faulty. This can generate a sudden breakdown or a gradual breakdown of the system owing to the repeated faulty operation of the particular HVAC system.

Therefore, there is a need for a common method of training the skilled or semi-skilled operators with regard to the working of the HVAC systems where the operators are given a broad introduction to all a/c parts and equipment. The operators are provided with a comprehensive approach on understanding their residential air conditioning system. There is a need for a program which will assist them on identifying all different parts of their HVAC system with a visual display by comparing the a/c parts to the human body. Further, by creating a human comparison, there needs to be an in-depth overview on how the HVAC systems operate from a real-life scenario, whereby the methodology followed here will allow the operators to extend equipment life, improve a/c efficiency, save energy cost, and enhance comfort control to apply on their residential air conditioning systems.

Hence, there is a long felt but unresolved need for a training system for a user to troubleshoot problems in an HVAC process by comparing HVAC components with human body parts, where it allows the technician and owner to have complete insight of the A/C & Heating System. This analogy concept by comparing the two will give the owner a better comprehensive knowledge of the system. In doing so, will exemplify the importance of what is expected of the technician in order to correct any issues that may come about. By empowering the two will lead to long term life expectancies of the system and cost efficiency to save money for both parties.

### SUMMARY OF THE INVENTION

The training system is disclosed herein for a user to troubleshoot problems in an HVAC process by comparing HVAC components with human body parts. The training system comprises a self-diagnostic thermostat configured to facilitate a user to compare components in the HVAC process to human body parts. Here, a thermostat is compared to a brain of the human body, a compressor of the HVAC components is compared to a heart of the human body, an evaporator of the HVAC components is compared to a pair of lungs of the human body, and suction and liquid dryers of the HVAC components are compared to kidneys of the human body.

In an embodiment, the other components of the HVAC process comprise refrigerant types, electrical circuits and wiring schematics, condensation drain line, high pressure refrigerant, low pressure refrigerant, copper tubing, UV lights, and exterior and interior shell of the system. In an embodiment, the refrigerant types are compared to blood types of the human body via the self-diagnostic thermostat. In an embodiment, the electrical circuits and wiring schematics are compared to the nerves of the human body via the self-diagnostic thermostat. In an embodiment, the condensation drain line is compared to the bladder or urine track of the human body via the self-diagnostic thermostat. In an embodiment, the high pressure refrigerant will be compared to high blood pressure of the human body via the self-diagnostic thermostat.

In an embodiment, the copper tubing is compared to arteries of the human body via the self-diagnostic thermostat. In an embodiment, the low pressure refrigerant are compared to low blood pressure of the human body via the self-diagnostic thermostat. In an embodiment, the ultra violet lights are compared to the eyes of the human body via the self-diagnostic thermostat. In an embodiment, the exterior and interior shell of the system are compared to skin and bones of the human body via the self-diagnostic thermostat.

### BRIEF DESCRIPTION OF THE DRAWINGS

FIG. 1A exemplarily illustrates a line drawing of components and processes involved in an HVAC system.

FIG. 1B exemplarily illustrates a comparison of the components and processes involved in an HVAC system to human body parts.

FIG. 2A exemplarily illustrates a front view of a thermostat in an HVAC system.

FIG. 2B exemplarily illustrates a cutaway view of the human brain, where the thermostat in FIG. 2A is compared to the human brain.

FIG. 3A exemplarily illustrates a front view of a compressor in an HVAC system.

FIG. 3B exemplarily illustrates a cutaway view of the human heart, where the compressor in FIG. 3A is compared to the human heart.

FIG. 4A exemplarily illustrates a front view of the suction and liquid dryers in the HVAC system.

FIG. 4B exemplarily illustrates a open view of the human kidneys, where the suction and liquid dryers in FIG. 4A is compared to the human kidneys.

FIG. 5A exemplarily illustrates a front view of the copper tubing in an HVAC system.

FIG. 5B exemplarily illustrates an open view of the human arteries, where the copper tubing in FIG. 5A is compared to the human arteries.

FIG. 6A exemplarily illustrates an open view of the human lungs, and how the human lung is affected by smoking.

FIG. 6B exemplarily illustrates an inner perspective view of an evaporator in an HVAC system, where the evaporator is compared to the human lung is affected by smoking as shown in FIG. 6A.

FIG. 6C exemplarily illustrates an inner perspective view of a clean evaporator.

### DETAILED DESCRIPTION OF THE INVENTION

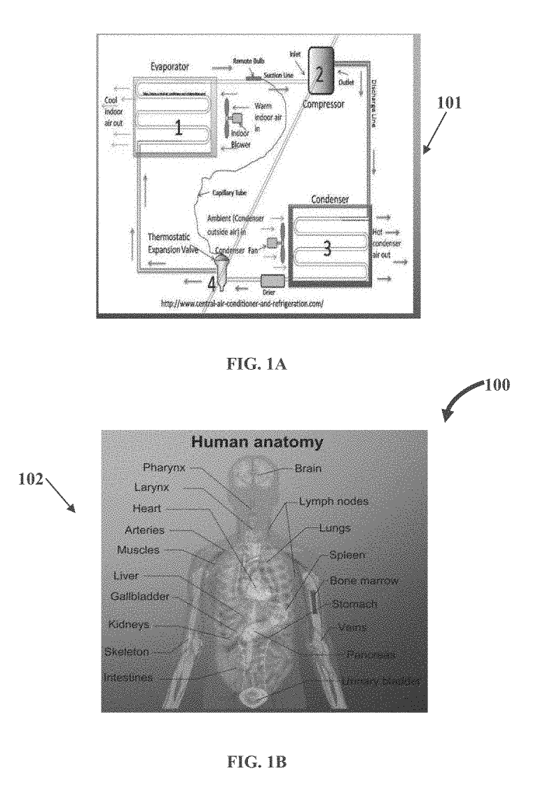

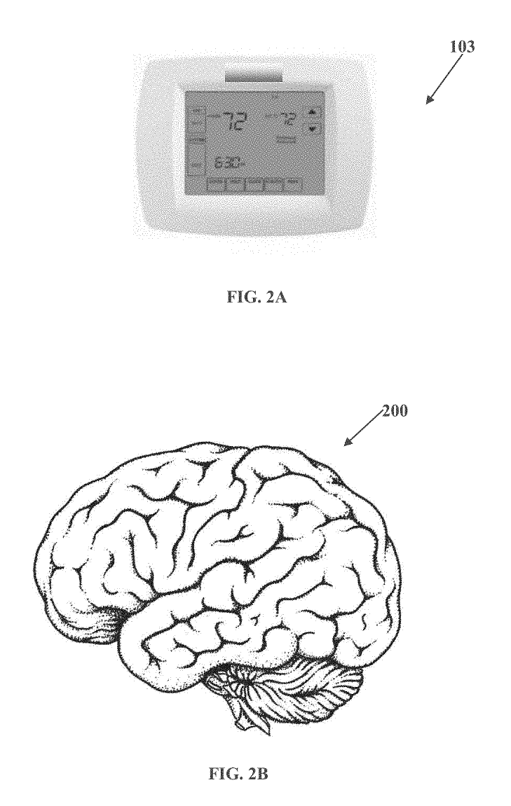

FIG. 1A exemplarily illustrates a line drawing of components and processes involved in an HVAC system 101, and FIG. 1B exemplarily illustrates a comparison of the components and processes involved in an HVAC system 101 to human body parts 102. The training system 100 is disclosed herein for a user to troubleshoot problems in an HVAC process by comparing HVAC components with human body parts 102. The training system 100, for example, defined as a visual display unit, comprises a self-diagnostic thermostat 103 configured to facilitate a user to compare components in the HVAC process to human body parts. Here, a self-diagnostic thermostat 103 is compared to a brain 200 of the human body 102 as shown in FIGS. 2A and 2B, a compressor 104 is compared to a heart 300 of the human body 102, an evaporator (not shown) is compared to a pair of lungs (not shown) of the human body 102, and suction and liquid dryers 105 are compared to kidneys 400 of the human body 102. In an embodiment, the other components of the HVAC process comprise refrigerant types, electrical circuits and wiring schematics (not shown), condensation drain line (not shown), high pressure refrigerant (not shown), low pressure refrigerant (not shown), copper tubing 106, UV lights (not shown), and exterior and interior shell (not shown) of the system.

FIG. 2A exemplarily illustrates a front view of a self-diagnostic thermostat 103 in an HVAC system 101, and FIG. 2B exemplarily illustrates a cutaway view of the human brain 200, where the self-diagnostic thermostat 103 in FIG. 2A is compared to the human brain 200. In an example, the T stat controls indoor and outdoor unit like the brain 200 controlling movements of the human body 102. The self-diagnostic thermostat 103 wiring are line nerves sending signals throughout the human body 102, for example, programmable and non-programmable self-diagnostic thermostat 103. The difference between an auto and on when operating the HVAC system 101 is also noted, and how to install the T-start is also compared. The selection to which is hard wire with common wire or battery operated only is also made between direct common wires or battery operated. The purpose of 2 or 4 degrees of separation on cooling and heating mode is compared. Emergency heat or secondary stages on the T-stat are determined. In an example, a wireless and Wi-Fi based thermostat is used for convenience.

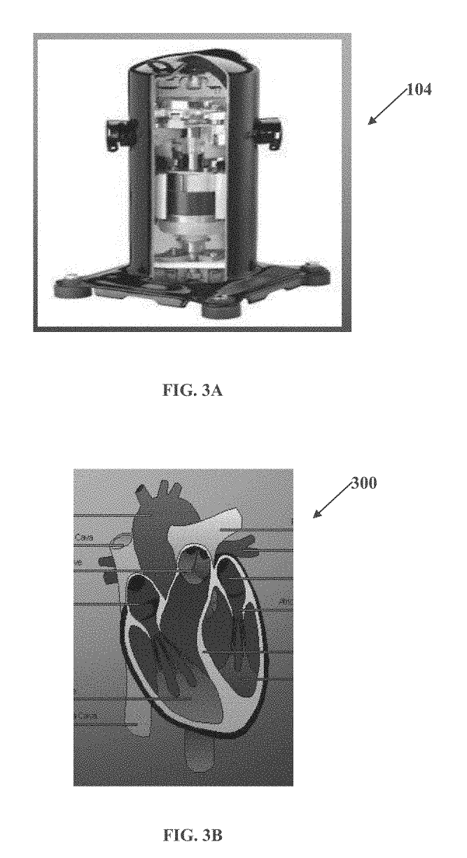

FIG. 3A exemplarily illustrates a front view of a compressor 104 in an HVAC system 101, and FIG. 3B exemplarily illustrates a cutaway view of the human heart 300, where the compressor 104 in FIG. 3A is compared to the human heart 300. In an example, the refrigerant material is supplied throughout the HVAC system 101 via the compressor 104 which is compared to the human heart 300 as disclosed in FIGS. 1A and 1B. The human heart 104 in comparison with the compressor 104, supplies blood throughout the human body 102. The analogous element to blood is the refrigerant material, for example, refrigerant R-22 is compared to blood type A, and refrigerant R-410A is compared to blood type B.

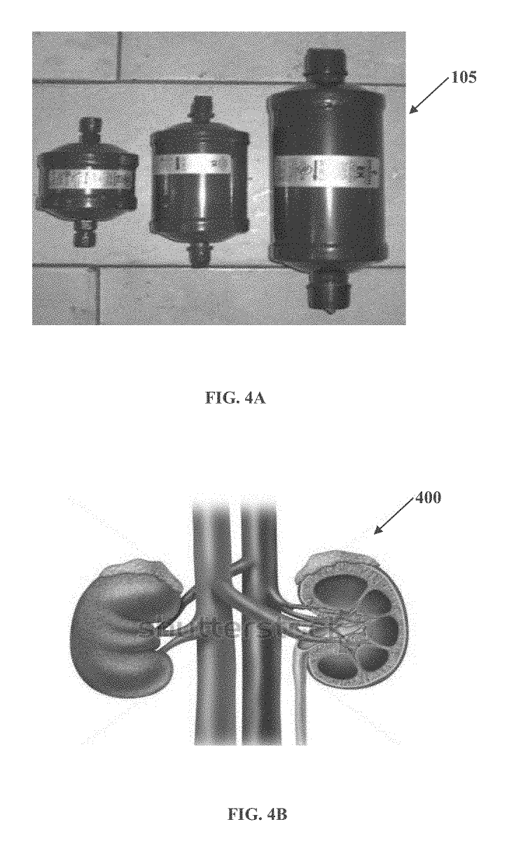

FIG. 4A exemplarily illustrates a front view of the suction and liquid dryers 105 in the HVAC system 101, and FIG. 4B exemplarily illustrates an open view of the human kidneys 400, where the suction and liquid dryers 105 in FIG. 4A is compared to the human kidneys 400. In an example, the suction and liquid dryers 105 or the A/C filter dryers are the kidneys of the refrigeration system by filtering out the contaminants.

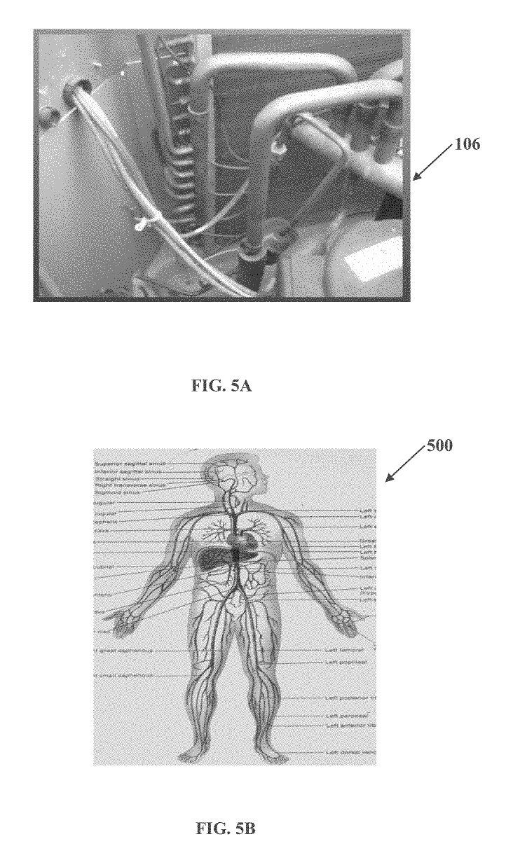

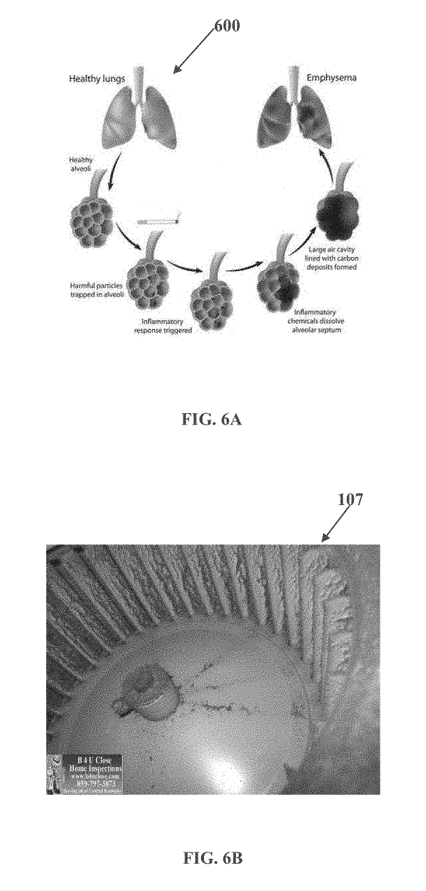

FIG. 5A exemplarily illustrates a front view of the copper tubing 106 in an HVAC system 101, and FIG. 5B exemplarily illustrates an open view of the human arteries 500, where the copper tubing 106 in FIG. 5A is compared to the human arteries 500. Copper tubing 106 can be illustrated as the arteries 500 of the A/C system by distributing refrigerant throughout the HVAC system 101. The operators or users, during comparative study should note that restriction or blockage of the refrigerant can cause several malfunctions to the HVAC system 101 or the A/C system, as compared to any blockage or restriction to the blood flow which can cause many problems, even death.

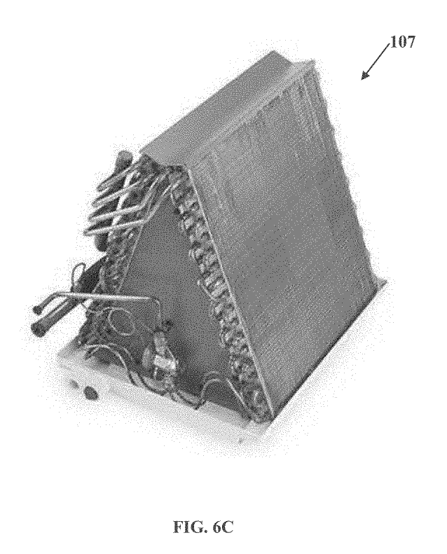

FIG. 6A exemplarily illustrates an open view of the human lungs 600, and how the human lung 600 is affected by smoking. FIG. 6B exemplarily illustrates an inner perspective view of an evaporator 107 in an HVAC system 101, where the evaporator 107 is compared to the human lung is affected by smoking as shown in FIG. 6A. FIG. 6C exemplarily illustrates an inner perspective view of a clean evaporator. Here, due to continuous smoking, the human lungs 600 gets contaminated with emphysema, as shown in FIG. 6A, therefore the evaporator 107 in an HVAC system 101 as shown in FIGS. 6B-6C is also subjected to similar kind of contamination if it's not maintained properly. The operators or users, during comparative study with air we breathe into our human lungs 600, should learn how to maintain indoor air quality by cleaning the unit evaporator coils and the return plenum.

In general, for example, during the comparison using the training system 100 the outside condensing unit is also checked for the following aspects where the operator has to study how to maintain the unit, how to learn the differences in the piping O/D, how to disconnect the correct sections, knowing how to read the data plate, what causes freeze up with ice in certain sections, how to insulate the pipes correctly, and the noises that the unit might generate. In addition, the presence of insects like wasps, ants, or the presence of spiders, amphibians or snakes is also checked. The suction line is properly insulated by the operator for efficient operation of the HVAC system 101. Other considerations such as location of the condensating unit is taken into consideration where about 10 inches of space is required to release the hot air, and about 5 inches of space is needed in order to bring the outside ambient air. The indoor air handling unit should also be maintained by cleaning the unit evaporator coils, and the return plenum. This can be compared to the human lungs which has a major contribution to the air inhaled and exhaled.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

What is claimed is:

1. A training system for a user to troubleshoot problems in an HVAC process by comparing HVAC components with human body parts, the training system comprising:
a self-diagnostic thermostat defined as a visual display unit configured to facilitate a user to compare components in the HVAC process to human body parts, wherein the self-diagnostic thermostat is compared to a brain of the human body; and
wherein a compressor of the HVAC components is compared to a heart of the human body;
wherein an evaporator of the HVAC components is compared to a pair of lungs of the human body; and
wherein suction and liquid dryers of the HVAC components are compared to kidneys of the human body.

2. The training system of claim 1, wherein other HVAC components of the HVAC process comprise refrigerant types, electrical circuits and wiring schematics, condensation drain line, high pressure refrigerant, low pressure refrigerant, UV lights, copper tubing, and exterior and interior shell of the system.

3. The training system of claim 2, wherein the refrigerant types are compared to blood types of the human body via the self-diagnostic thermostat.

4. The training system of claim 2, wherein the copper tubing is compared to arteries of the human body via the self-diagnostic thermostat.

5. The training system of claim 2, wherein the electrical circuits and wiring schematics are compared to the nerves of the human body via the self-diagnostic thermostat.

6. The training system of claim 2, wherein the condensation drain line is compared to the bladder or urine track of the human body via the self-diagnostic thermostat.

7. The training system of claim 2, wherein the high pressure refrigerant is compared to high blood pressure of the human body via the self-diagnostic thermostat.

8. The training system of claim 2, wherein the low pressure refrigerant are compared to low blood pressure of the human body via the self-diagnostic thermostat.

9. The training system of claim 2, wherein the ultra violet lights are compared to the eyes of the human body via the self-diagnostic thermostat.

10. The training system of claim 2, wherein the exterior and interior shell of the system are compared to skin and bones of the human body via the self-diagnostic thermostat.
